(19) United States
(12) Patent Application Publication
(10) Pub. No.: US 2018/0292900 A1
(43) Pub. Date: Oct. 11, 2018

(54) Adhesive stylus for finger

(71) Applicant: Rose M. Mercado Saddler, Bexar, TX (US)

(72) Inventor: Rose M. Mercado Saddler, Bexar, TX (US)

(21) Appl. No.: 15/731,033

(22) Filed: Apr. 10, 2017

(51) Int. Cl. G06F 3/01; G06F 3/0354

(52) U.S. Cl. CPC G06F 3/014; G06F 2203/0331; G06F 3/03545

(57) ABSTRACT

Mobile phone or ipad® or notebook stylus that is glued and or adhered to the tip of the finger or the skin or the clothing (i.e. gloves) or under the fingernail for use as an alternative to “pen” and compact type styluses.

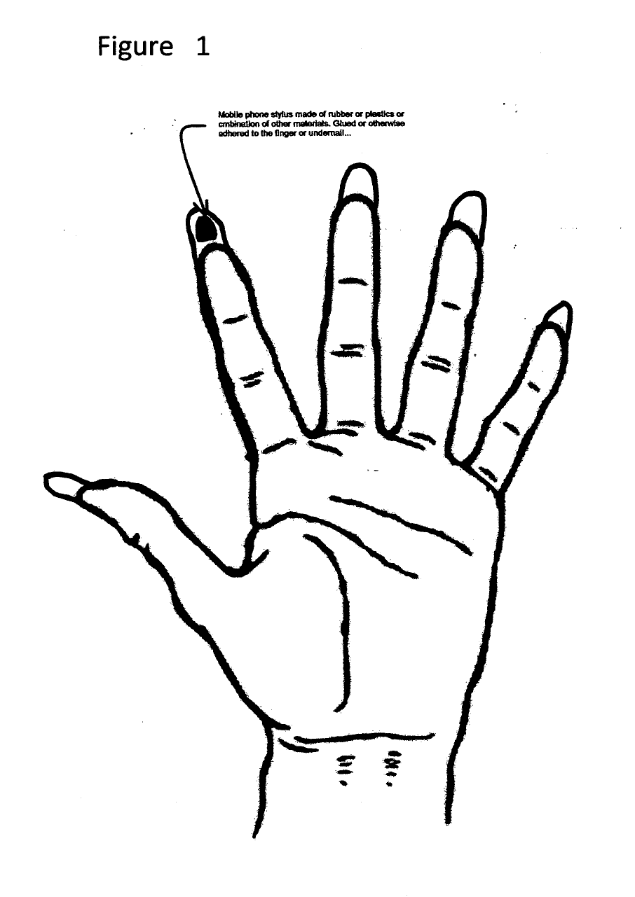

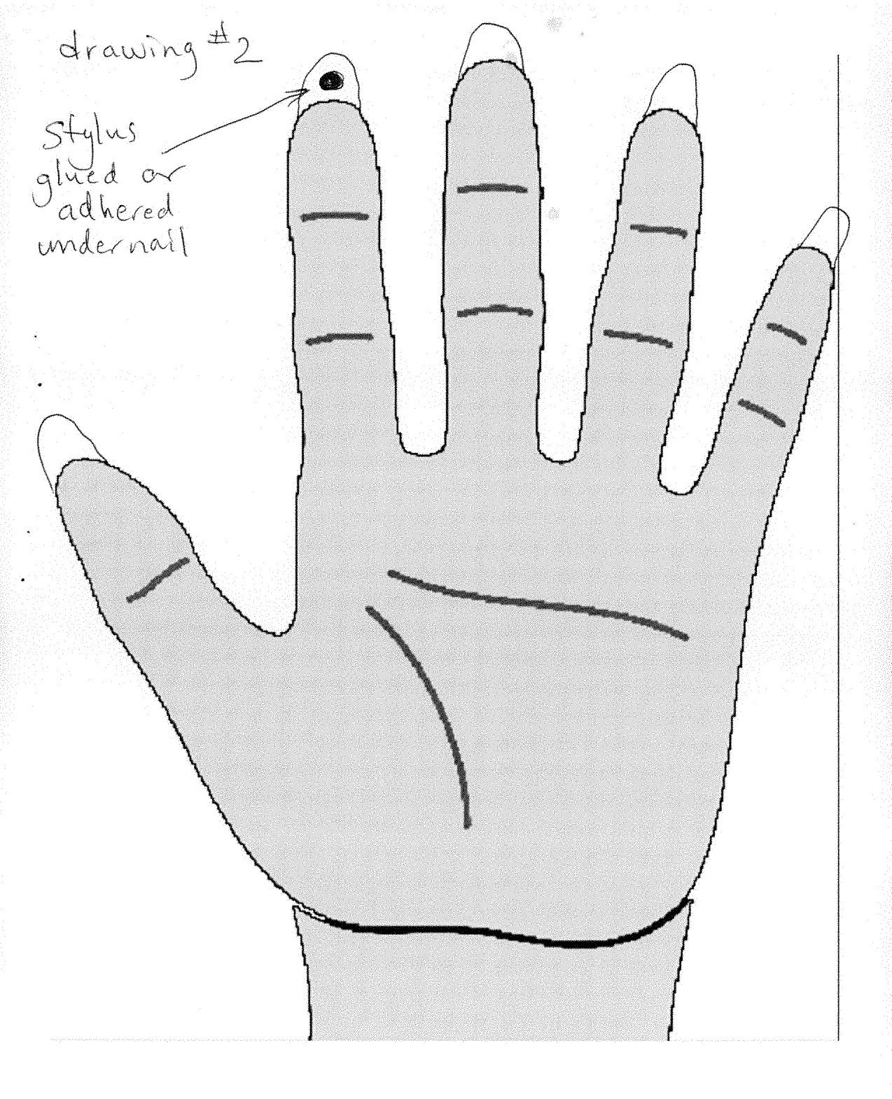

1. Styluses sizes can be any size.

2. Styluses can be any type rubber.

3. Styluses can be adhered with any type glue or adhesive.

4. Drawing one (1) references placement on skin.

5. Drawing two (2) references placement under fingernail.

6.Can be glued/adhered to clothing as well.

1. All types of rubber may be used.

2. All types of glue and or adhesives can be used.

3. Regardless of rubber type or glue type the stylus “tip” can be adhered wherever the user wants.

4. Eliminates the need to carry, transport or buy “full size” or “compact” size styluses, which are easily lost and hard to keep track of.

5. When adhesion “fails” re-gluing restores the glued/adhered stylus for use, or consumer can buy a new one, and adhere, ready for use.
